(19) United States
(12) Patent Application Publication
(10) Pub. No.: US 2026/0148101 A1
(43) Pub. Date: May 28, 2026

(54) MESSAGING ONLINE SYSTEM USERS IN RESPONSE TO PREDICTED LIKELIHOODS OF ORDER PICKUP USING MACHINE LEARNING MODEL

(71) Applicant: Maplebear Inc., San Francisco, CA (US)

(72) Inventors: Hua Xiao, Toronto (CA); Brent Scheibelhut, Toronto (CA); Akshay Bagai, Toronto (CA); Mark Oberemk, Toronto (CA); Charles Wesley, San Diego, CA (US); Amalia Rothschild-Keita, Berkeley, CA (US)

(21) Appl. No.: 18/963,243

(22) Filed: Nov. 27, 2024

(51) Int. Cl. G06N 5/022

(52) U.S. Cl. CPC G06N 5/022

(57) ABSTRACT

An online system receives a request from a client device associated with a user to place an order for pickup from a source location during a timeframe and identifies candidate remedial actions associated with the order based on the timeframe and a current time. The system retrieves user data for the user and accesses a machine-learning model. For each candidate remedial action, the system applies the model to predict, based on the user data and order data for the order, a likelihood the user will pick up the order if the candidate remedial action is taken and computes an associated value based on the likelihood. The system selects a remedial action from the candidate remedial actions based on the values, generates, based on the selected remedial action, a message associated with the order that includes a set of selectable options, and sends the message to the client device.

### BACKGROUND

Online systems may allow their users to place orders for pickup from source locations during timeframes specified by the users. Once the orders are placed, pickers or employees of the source locations may service the orders by collecting items included in the orders from the source locations and setting them aside at the source locations prior to the timeframes. The users may then pick up their orders when they arrive at the source locations during the specified timeframes.

However, users at times may fail to pick up their orders from source locations during the timeframes (e.g., if they forget and later remember to do so, if they are running late due to adverse weather conditions or heavy traffic, etc.) or they may fail to pick up their orders altogether (e.g., if they forget, if they decide they no longer want the orders, etc.), which may result in various negative consequences. For example, employees of source locations may be burdened with restocking items included in orders that are not picked up. In this example, any perishable items (e.g., dairy, frozen food, fresh meat, etc.), prepared items (e.g., hot soup or pizza), or personalized items (e.g., deli sandwiches or birthday cakes) included in the orders may go to waste if they cannot be restocked and sources that operate the source locations may have to bear the cost of the wasted items. Although online systems may send messages to their users reminding them to pick up the orders, doing so may be both technically burdensome (e.g., due to the resources required to keep track of the timeframes for picking up the orders, the number of reminders sent for each order, etc.) and ineffective (e.g., if the users decide they no longer want the orders).

### SUMMARY

In accordance with one or more aspects of the disclosure, an online system messages online system users based on predicted likelihoods of order pickup in response to remedial actions. More specifically, an online system receives a request from a client device associated with a user of the online system to place an order for pickup from a source location during a timeframe and identifies candidate remedial actions associated with the order based on the timeframe and a current time. The online system retrieves a set of user data for the user, in which the set of user data includes historical order information associated with the user, and accesses a machine-learning model trained to predict a likelihood that the user will pick up the order. For each candidate remedial action, the online system applies the machine-learning model to predict the likelihood that the user will pick up the order if the candidate remedial action is taken based on the set of user data for the user and a set of order data for the order and computes a value associated with the candidate remedial action based on the likelihood. The online system selects a remedial action from the candidate remedial actions based on the value associated with each candidate remedial action and generates a message associated with the order based on the selected remedial action, in which the message includes a set of selectable options. The online system then sends the message to the client device, in which sending the message causes the client device to display the message. In one or more embodiments, when applying the machine-learning model to predict the likelihood that the user will pick up the order if a candidate remedial action is taken, the model also makes the prediction based on a set of contextual information associated with the order (e.g., a set of weather or traffic conditions associated with picking up the order).

Thus, the online system automatically generates and sends a message to a client device associated with a user who placed an order for pickup from a source location based on a remedial action that is selected based on a predicted likelihood that the user will pick up the order if the remedial action is taken. Furthermore, by selecting the remedial action based on a value (e.g., a cost of restocking items or wasted perishable or personalized items) associated with each of multiple candidate remedial actions, the online system may consider various negative consequences that may result if the user fails to pick up their order from the source location when selecting the remedial action. Moreover, by predicting the likelihood that the user will pick up the order if a candidate remedial action is taken based on a set of contextual information associated with the order, the online system also may consider additional factors that are specific to the order that may affect the likelihood that the user will pick up the order.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a flowchart of a method for messaging an online system user based on predicted likelihoods the user will pick up an order in response to remedial actions, in accordance with one or more embodiments.

FIG. 4 is a process flow diagram for messaging an online system user based on predicted likelihoods the user will pick up an order in response to remedial actions, in accordance with one or more embodiments.

### DETAILED DESCRIPTION

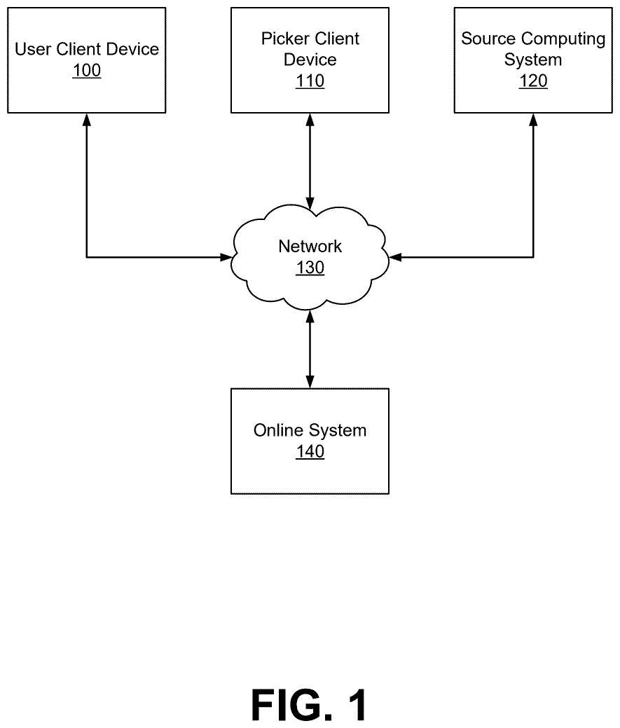

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 may be a personal or mobile computing device, such as a smartphone, a tablet, a laptop computer, or a desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, refers to a good or a product that may be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more source locations from which the ordered items should be collected.

The user client device 100 presents an ordering interface to the user. The ordering interface is a user interface that the user may use to place an order with the online system 140. The ordering interface may be part of a client application operating on the user client device 100. The ordering interface allows the user to search for items that are available through the online system 140 and the user may select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the items should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 may be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source location. The picker client device 110 presents the items that are included in the user's order to the picker in a collection interface. The collection interface is a user interface that provides information to the picker identifying items to collect for a user's order and indicating the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source location, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker may use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may identify the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 provides instructions to a picker for delivering the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they may use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be a user client device 100 being operated by a user collecting items for themselves within the source location. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, a warehouse, or any other source location from which a picker may collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Furthermore, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

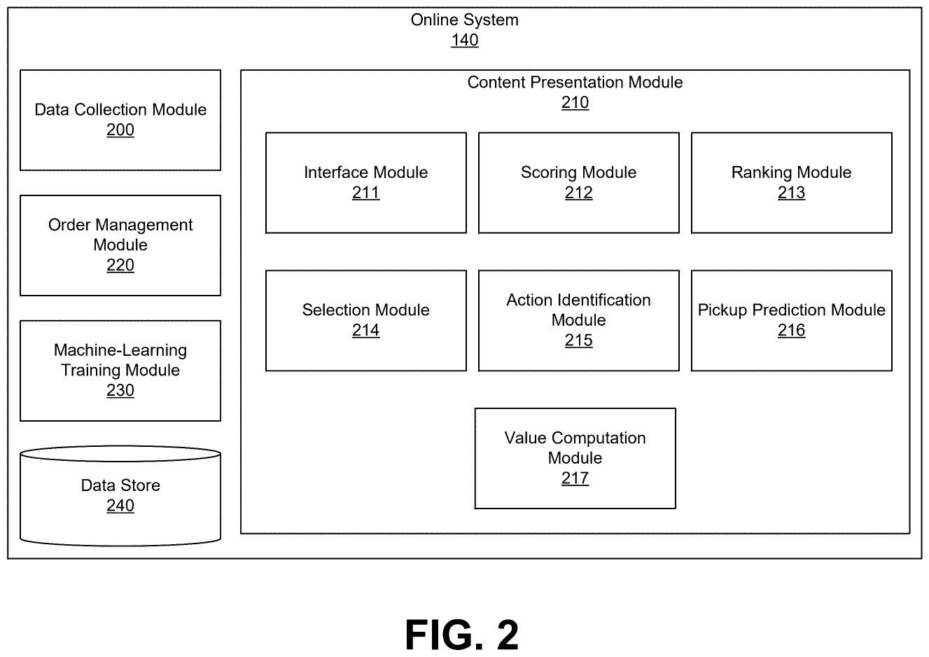

As an example, the online system 140 may allow a user to order groceries from a grocery store source. The user's order may specify which groceries they want to be delivered from the grocery store source and the quantities of each of the groceries. The user's client device 100 transmits the user's order to the online system 140 and the online system 140 selects a picker to travel to the grocery store source location to collect the groceries ordered by the user. The online system 140 transmits an offer to the picker for the picker to service the order in exchange for consideration and, if the picker accepts the offer, the picker collects the groceries from the grocery store source location. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

The data collection module 200 collects user data, which is information or data that describe characteristics of a user. User data may include a user's name, address (e.g., home or work), preferences, (e.g., shopping or dietary preferences, favorite items, sources, source locations, or cuisines, etc.), or stored payment instruments. User data also may indicate whether a user is new to the online system 140 (e.g., based on a date that the user placed their first order with the online system 140, a number of orders the user has placed with the online system 140, etc.). User data also may include demographic information associated with a user (e.g., age, gender, geographical region, etc.) or household information associated with the user (e.g., a number of people in the user's household, whether the user's household includes children or pets, etc.). Furthermore, user data may include a current location associated with a user (e.g., a location of a user client device 100 associated with the user). The user data also may include default settings established by the user, such as a default source/source location, payment instrument, delivery location, or delivery timeframe.

User data further may include historical information associated with a user, such as historical conversion information, which may include historical order information. For example, user data may include historical order information describing previous orders a user placed with one or more sources. In this example, the historical order information may describe items included in each order (e.g., an item category, a size, a brand, a quantity, a price, a perishability, storage requirements, packaging information, etc. associated with each item), a number of each item included in each order, a total value of the items included in each order, or a time each order was placed. In the above example, the historical order information also may describe a source location from which the items included in each order were collected, a delivery time for each order, whether each order was offered to the user (e.g., if the order was not picked up by another user), any discounts, fees (e.g., delivery or restocking fees), or incentives (e.g., coupons, free items, etc.) associated with each order, etc. Continuing with this example, for each previous order a user placed for pickup from a source location, the historical order information also may describe a pickup timeframe during which the user was to pick up the order or a time at which the user picked up the order from the source location (if any). In this example, the historical order information also may include contextual information associated with each previous order, such as a set of weather conditions (e.g., rain, hail, snow, etc.), a set of traffic conditions (e.g., an amount of traffic, a number of detours, etc.), a day of the week, a time of the day, etc. associated with servicing or picking up the order.

Additionally, user data further may include additional types of historical information associated with a user, such as historical purchase information, or any other suitable types of information. For example, user data may include historical purchase information describing previous purchases the user made for themselves from source locations, such as information describing items included in each purchase, a time each purchase was made, a source location from which each purchase was made, etc. The data collection module 200 may collect the user data from sensors on the user client device 100 or based on the user's interactions with the online system 140. The data collection module 200 also may collect the user data from other components of the online system 140, a source computing system 120, a third-party system (e.g., a website or an application), or any other suitable source.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for an item. Item data also may describe the perishability of items (e.g., based on a best by, use by, or sell by date for each item, a freshness of each item, etc.), storage requirements for items (e.g., below or above a threshold temperature or humidity level), or packaging information for items (e.g., prepackaged, sealed, loose, etc.). Item data further may describe restocking or reselling procedures for items. For example, item data may indicate that certain made-to-order items (e.g., personalized birthday cakes) may not be restocked or resold or that prepared or transformed items (e.g., meat from a butcher counter) may not be restocked. In this example, item data also may indicate that prepackaged, nonperishable items (e.g., canned foods) may be restocked (e.g., on a shelf), while frozen items may be restocked in a freezer if their temperature has not fallen below a threshold temperature. Item data also may describe restocking or storage costs for items. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular source location), the item data may include a time that the item was last found, a time that the item was last not found (a picker looked for the item but could not find it), the rate at which the item is found, or the popularity of the item. The data collection module 200 may collect item data from a source computing system 120, a picker client device 110, or a user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. In some embodiments, item categories may be broader in that the same item category may include item types that are related to a common theme, found in the same department, etc. For example, items such as apples, oranges, lettuce, and cucumbers may be included in a “produce” item category. As an additional example, items such as bread, pasta, and cookies that are gluten-free may be included in a “gluten-free” item category, while items such as tortilla chips and tofu that are non-GMO may be included in a “non-GMO” item category. Furthermore, in various embodiments, an item may be included in multiple item categories. For example, non-fat milk may be included in a “non-fat milk” item category, a “milk” item category, and a “dairy” item category. The item categories may be human-generated and human-populated with items. The item categories also may be generated automatically by the online system 140 (e.g., using a clustering algorithm).

The data collection module 200 also collects picker data, which is information or data describing characteristics of pickers. For example, the picker data for a picker may include the picker's name, the picker's location, how often the picker has serviced orders for the online system 140, a user rating for the picker, the source locations from which the picker has collected items, or the picker's previous shopping history. Additionally, the picker data may include preferences expressed by the picker, such as their preferred source locations for collecting items, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data describing characteristics of an order. For example, order data may include item data for items that are included in an order, a number of each item in the order, a total value of the items included in the order, a delivery location for the order, a user associated with the order, a source location from which the user wants the ordered items collected, or a timeframe within which the user wants the order delivered. In this example, the item data may include an item category, a size, a brand, a quantity, a price, a perishability, storage requirements, packaging information, restocking or reselling procedures, any costs (e.g., restocking or storage), etc. associated with each item. In the above example, if the user placed the order for pickup from the source location, the order data also may describe a pickup timeframe during which the user is to pick up the order. In this example, the order information also may include contextual information associated with the order, such as a set of weather conditions (e.g., rain, hail, snow, etc.), a set of traffic conditions (e.g., an amount of traffic, a number of detours, etc.), a day of the week, a time of the day, etc. associated with servicing or picking up the order. Order data also may include information describing any incentives (e.g., coupons for subsequent orders, free items, etc.), fees (e.g., delivery fees), or discounts associated with an order, such as a type or an amount of each incentive, an amount of each discount, etc. Order data may further include information describing how the order was serviced, such as which picker serviced the order, when the order was delivered, or a rating that the user gave the delivery of the order. In some embodiments, the order data include user data for users associated with the order, such as user data for a user who placed the order or picker data for a picker who serviced the order.

In some embodiments, the data collection module 200 also may determine or derive information from other data stored in the data store 240, data received from a third-party system (e.g., a website or an application), or any other suitable source and then store this information in the data store 240 (e.g., in association with some or all of the data from which it was determined/derived). For example, based on historical order information describing a pickup timeframe for a previous order placed by a user and a time at which the user picked up the order, the data collection module 200 may determine whether the user picked up the order during the pickup timeframe and if not, a number of minutes before or after the pickup timeframe at which the user picked up the order. In this example, if the historical order information does not include a time at which the user picked up the order, the data collection module 200 may determine that the user did not pick up the order. Furthermore, in this example, the data collection module 200 also may derive a historical rate at which the user picked up previous orders the user placed for pickup or a percentage of the previous orders that the user picked up (e.g., before, within, or after pickup timeframes for the orders). As an additional example, based on historical conversion information describing a total value of items included in each previous order placed by a user or in each previous purchase made by the user, the data collection module 200 may determine a net present value (NPV) associated with the user.

The following illustrates additional examples of how the data collection module 200 may determine or derive information from other data stored in the data store 240, data received from a third-party system, etc. Suppose that a set of order data includes information describing an order a user places for pickup from a source location, such as information describing the source location and a pickup timeframe for the order, and that a set of user data describes a current location or address (e.g., home or work) associated with the user. In this example, based on the set of order data, the set of user data, and information obtained from a third-party navigation website, the data collection module 200 may derive an estimated arrival time for the user at the source location. In the above example, based on a difference between the pickup timeframe and the estimated arrival time, the data collection module 200 may derive an amount of time the order will likely be stored before it is picked up. In this example, based on the order data describing each item included in the order (e.g., perishability, storage requirements, packaging information, etc.), the data collection module 200 also may derive a likely freshness of each item at pickup and any additional cost associated with storing the order (e.g., in a freezer or a refrigerator). In the above example, based on the order data describing each item included in the order, the data collection module 200 also may derive a cost associated with collecting the items in the order (e.g., by pickers or employees of the source location). Furthermore, in the above example, based on the source location and the current location or address associated with the user and the information obtained from the third-party navigation website, the data collection module 200 may derive a set of traffic conditions associated with picking up the order. Similarly, in the above example, based on information obtained from a third-party weather application, the data collection module 200 also may derive a set of weather conditions associated with picking up the order.

While user data, picker data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. Components of the content presentation module 210 include: an interface module 211, a scoring module 212, a ranking module 213, a selection module 214, an action identification module 215, a pickup prediction module 216, and a value computation module 217, which are further described below.

The interface module 211 generates and transmits an ordering interface for a user to order items. The interface module 211 populates the ordering interface with items that the user may select for adding to their order. In some embodiments, the interface module 211 presents a catalog of all items that are available to the user, which the user can browse to select items to order. Other components of the content presentation module 210 may identify items that the user is most likely to order and the interface module 211 may then present those items to the user. For example, the scoring module 212 may score items and the ranking module 213 may rank the items based on their scores. In this example, the selection module 214 may select items with scores that exceed some threshold (e.g., the top n items or the p percentile of items) and the interface module 211 then displays the selected items.

The interface module 211 also may receive a request from a user client device 100 associated with a user of the online system 140 to place a new order for pickup from a source location during a pickup timeframe. The request may include information describing the user, the pickup timeframe, the source location, each item included in the new order (e.g., an item identifier, an item category, a brand, a price, a perishability, storage requirements, packaging information, etc. associated with each item), a number of each item included in the new order, a total value of the items included in the new order, etc. The pickup timeframe during which the new order is to be picked up from the source location may be specified by the user. For example, a pickup timeframe may correspond to a one-hour window (e.g., between 2:00 p.m. and 3:00 p.m.) after a time a new order is placed, in which the one-hour window may be selected from multiple possible one-hour windows by a user who placed the order.

Additionally, the interface module 211 may generate a message associated with a new order and send the message to a user client device 100 associated with a user, causing the user client device 100 to display the message. The message generated by the interface module 211 may include a set of selectable options. Examples of selectable options that may be included in the message include: an option to claim an incentive (e.g., a coupon for a subsequent order, a free item, etc.) for picking up the new order, an option to accept a later pickup timeframe for the new order (e.g., with a discount available for earlier timeframes), an option to change the new order from a pickup order to a delivery order, an option to cancel the new order, etc. The interface module 211 may generate the message based on a remedial action selected by the selection module 214, as described below, or based on any other suitable types of information. For example, if the remedial action selected by the selection module 214 corresponds to reminding a user to pick up a new order from a source location, the interface module 211 may generate a message including a reminder to pick up the new order from the source location within a pickup timeframe for the new order. Alternatively, in the above example, if the remedial action corresponds to providing an incentive for the user to pick up the new order, in which the incentive corresponds to a free item, the message may instead describe the incentive and include an option to claim the free item once the user arrives at the source location. In some embodiments, the interface module 211 sends the message to the user client device 100 once it generates the message, while in other embodiments, it sends the message at a later time. For example, if the interface module 211 generates a message associated with a new order that includes an incentive for picking up the new order, the interface module 211 may send the message to a user client device 100 associated with a user who placed the new order after a pickup timeframe for the new order has passed.

The scoring module 212 may use an item selection model to score items for presentation to a user. An item selection model is a machine-learning model that is trained to score items for a user based on item data for the items and user data for the user. For example, the item selection model may be trained to determine a likelihood that a user will order an item. In some embodiments, the item selection model uses item embeddings describing items and user embeddings describing users to score items. These item embeddings and user embeddings may be generated by separate machine-learning models and may be stored in the data store 240.

In some embodiments, the scoring module 212 scores items based on a search query received from the user client device 100. A search query is free text for a word or set of words that indicate items of interest to the user. The scoring module 212 scores items based on a relatedness of the items to the search query. For example, the scoring module 212 may apply natural language processing (NLP) techniques to the text in the search query to generate a search query representation (e.g., an embedding) that represents characteristics of the search query. The scoring module 212 may use the search query representation to score candidate items for presentation to a user (e.g., by comparing a search query embedding to an item embedding).

In some embodiments, the scoring module 212 scores items based on a predicted availability of an item. The scoring module 212 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The scoring module 212 may apply a weight to the score for an item based on the predicted availability of the item. Alternatively, an item may be filtered out from presentation to a user by the selection module 214 based on whether the predicted availability of the item exceeds a threshold.

Once the value computation module 217 (described below) computes a value associated with each of multiple candidate remedial actions identified by the action identification module 215 (also described below), the selection module 214 may select a remedial action from the candidate remedial actions. The selection module 214 may do so based on the value associated with each candidate remedial action. For example, a remedial action selected by the selection module 214 may correspond to a candidate remedial action associated with a minimum cost (e.g., a highest expected value). In some embodiments, the ranking module 213 ranks the candidate remedial actions based on the value associated with each candidate remedial action or based on any other suitable types of information. In such embodiments, the selection module 214 may then select the remedial action based on the ranking. In the above example, the ranking module 213 may rank the candidate remedial actions based on the value associated with each candidate remedial action, such that a candidate remedial action associated with a lowest cost (e.g., a highest expected value) is ranked the highest and a candidate remedial action associated with a highest cost (e.g., a lowest expected value) is ranked the lowest. Continuing with this example, the selection module 214 may select a remedial action corresponding to the highest ranked candidate remedial action.

The action identification module 215 identifies candidate remedial actions associated with a new order a user has placed for pickup from a source location during a pickup timeframe. The action identification module 215 may do so based on the pickup timeframe and a current time (e.g., by determining whether the current time is before, within, or after the pickup timeframe) or based on any other suitable types of information. Examples of candidate remedial actions include: reminding the user to pick up the new order, providing an incentive (e.g., a coupon for a subsequent order, a free item, etc.) for the user to pick up the new order, suggesting a later pickup timeframe for the new order (e.g., with a discount available for earlier timeframes), or suggesting the new order be delivered to a delivery location associated with the user (e.g., with a delivery fee). Additional examples of candidate remedial actions include: cancelling the new order, restocking one or more items included in the new order (e.g., with a restocking fee), offering the new order to another user of the online system 140 (e.g., for pickup or delivery, at a discount, etc.), or any other suitable types of candidate remedial actions. In embodiments in which a candidate remedial action identified by the action identification module 215 is associated with an incentive, a discount, or a fee, additional candidate remedial actions identified by the action identification module 215 may be of the same type, but associated with different incentives, discounts, or fees. For example, the action identification module 215 may identify candidate remedial actions associated with a new order, in which each candidate remedial action is associated with a different amount of an incentive, discount, or fee.

In embodiments in which a candidate remedial action associated with a new order is associated with an incentive, a discount, or a fee, the incentive, discount, or fee may be determined by the action identification module 215. The action identification module 215 may make the determination based on order data for the new order, user data for a user who placed the new order, or any other suitable types of information. For example, if the action identification module 215 identifies a candidate remedial action corresponding to offering a new order to a user at a discount, the action identification module 215 may determine an amount of the discount that is proportional to a total value of the items included in the new order. As an additional example, suppose that the action identification module 215 identifies a candidate remedial action corresponding to an incentive for a user to pick up a new order. In this example, the action identification module 215 may determine an amount of a coupon for a subsequent order to provide as the incentive, in which the amount is proportional to a net present value (NPV) associated with the user or to an amount of a restocking fee associated with the new order. Alternatively, in the above example, the amount of the coupon may be based on a newness of the user to the online system 140, such that the amount is inversely proportional to an amount of time elapsed since a date that the user placed their first order with the online system 140 or to a number of orders the user has placed with the online system 140. In the above example, if the candidate remedial action instead corresponds to restocking one or more items included in the new order, the action identification module 215 may determine an amount of a restocking fee that is inversely proportional to the NPV associated with the user. Alternatively, in this example, the restocking fee may be a fixed amount that is based on whether the NPV associated with the user is at least a threshold value (e.g., $5.00 if the NPV is less than the threshold value).

The following illustrates an example of how the action identification module 215 may identify candidate remedial actions associated with a new order a user has placed for pickup from a source location during a pickup timeframe. Suppose that the action identification module 215 determines that a current time or an estimated arrival time for the user at the source location derived by the data collection module 200 is before or within the pickup timeframe. In this example, the action identification module 215 may identify candidate remedial actions associated with the new order including reminding the user to pick up the new order, providing an incentive for the user to pick up the new order, suggesting a later pickup timeframe for the new order, or suggesting the new order be delivered to a delivery location associated with the user. Alternatively, in the above example, suppose that the action identification module 215 determines that the current time or the estimated arrival time for the user at the source location is after the pickup timeframe. In this example, the action identification module 215 also or alternatively may identify additional candidate remedial actions associated with the new order including cancelling the new order, restocking one or more items included in the new order, or offering the new order to another user of the online system 140 at a discount.

The pickup prediction module 216 retrieves a set of user data from the data store 240, in which the set of user data is for a user who has placed a new order for pickup from a source location during a pickup timeframe. For example, the pickup prediction module 216 may retrieve a set of user data including historical order information describing previous orders a user placed with one or more sources. In this example, the historical order information may include item data describing items included in each previous order, a number of each item included in each previous order, a total value of the items included in each previous order, a time each previous order was placed, a source location from which the items included in each previous order were collected, and a pickup timeframe for each previous order. Continuing with this example, the historical order information also may describe a time at which the user picked up each previous order (if any) or any incentives (e.g., coupons for subsequent orders, free items, etc.), discounts, or fees (e.g., delivery or restocking fees) associated with each previous order (e.g., a type or an amount of each incentive, an amount of each discount or fee, etc.). In this example, the historical order information further may include a historical rate at which the user picked up their previous pickup orders or a percentage of the previous pickup orders that the user picked up (e.g., before, within, or after pickup timeframes for the orders). In the above example, the historical order information also may include contextual information associated with each previous order, such as a set of weather conditions (e.g., rain, hail, snow, etc.), a set of traffic conditions (e.g., an amount of traffic, a number of detours, etc.), a day of the week, a time of the day, etc. associated with picking up each previous order. Continuing with this example, the set of user data also may include a net present value (NPV), a current location, or demographic or household information associated with the user, an estimated arrival time for the user at the source location from which the new order is to be picked up, or information indicating whether the user is new to the online system 140.

In some embodiments, the pickup prediction module 216 also retrieves additional types of data from the data store 240, such as a set of order data for a new order a user has placed for pickup from a source location during a pickup timeframe, or any other suitable types of data. In the above example, the pickup prediction module 216 also may retrieve a set of order data for the new order, in which the set of order data describes the source location from which the new order is to be picked up, the pickup timeframe for the new order, and information describing the user. In this example, the set of order data also may include item data for items included in the new order, such as an item identifier, an item category, a size, a brand, a quantity, a price, a perishability, storage requirements, packaging information, restocking or reselling procedures, any costs (e.g., restocking or storage), etc. associated with each item. Continuing with this example, the set of order data also may describe a number of each item included in the new order and a total value of the items included in the new order. In the above example, the set of order information also may include contextual information associated with the new order, such as a set of weather conditions (e.g., rain, hail, snow, etc.), a set of traffic conditions (e.g., an amount of traffic, a number of detours, etc.), a day of the week, a time of the day, etc. associated with picking up the new order.

For each candidate remedial action identified by the action identification module 215, the pickup prediction module 216 also predicts a likelihood that a user who has placed a new order for pickup from a source location during a pickup timeframe will pick up the new order if the candidate remedial action is taken. The pickup prediction module 216 may do so based on a set of user data for the user, a set of order data for the new order, or any other suitable types of information. For example, suppose that historical order information indicates that a user has always picked up orders they placed for pickup during pickup timeframes for the orders, that the user has never had orders delivered to them, and that the user often orders items that are on sale. In the above example, suppose also that a new order that the user has placed for pickup from a source location is very similar to the user's previous orders (e.g., based on items included in the orders, contextual information associated with picking up the orders, etc.). Continuing with this example, the pickup prediction module 216 may predict a likelihood that the user will pick up the new order if each of multiple remedial actions identified by the action identification module 215 is taken (e.g., 95% if the user is reminded to pick up the new order, 98% if the user is provided with an incentive to pick up the new order, etc.). In various embodiments, the pickup prediction module 216 predicts multiple likelihoods that the user will pick up the new order for each candidate remedial action (e.g., as the pickup timeframe approaches, when the current time is within the pickup timeframe, or when the pickup timeframe has passed). In some embodiments, the pickup prediction module 216 also predicts a likelihood that the user will pick up the new order if no remedial action is taken. In such embodiments, the pickup prediction module 216 may determine whether the predicted likelihood is at least a threshold likelihood and may only predict the likelihood for each candidate remedial action identified by the action identification module 215 if the predicted likelihood is less than the threshold likelihood.

In some embodiments, the pickup prediction module 216 predicts a likelihood that a user who has placed a new order for pickup from a source location during a pickup timeframe will pick up the new order if a candidate remedial action is taken using a pickup prediction model. A pickup prediction model is a machine-learning model trained to predict a likelihood that a user who has placed an order for pickup from a source location during a pickup timeframe will pick up the order if a set of candidate remedial actions is taken. To use the pickup prediction model, the pickup prediction module 216 may access the model (e.g., from the data store 240) and apply the model to a set of inputs. The set of inputs may include data retrieved by the pickup prediction module 216 described above, information describing a set of candidate remedial actions, or any other suitable types of information. Once the pickup prediction module 216 applies the pickup prediction model to the set of inputs, the pickup prediction module 216 may receive an output from the model, which may include a value corresponding to the likelihood that the user will pick up the new order if the set of candidate remedial actions is taken. For example, if the pickup prediction module 216 applies the pickup prediction model to a set of inputs including a set of user data for a user and a set of order data describing a new order the user has placed for pickup from a source location, the pickup prediction module 216 may receive an output from the model including a value corresponding to a likelihood that the user will pick up the new order if no candidate remedial action is taken. In the above example, if the set of inputs also describes a candidate remedial action corresponding to sending a reminder to the user to pick up the new order, the value included in the output may correspond to a likelihood that the user will pick up the new order if the reminder is sent to the user. In some embodiments, the pickup prediction model is trained by the machine-learning training module 230, as described below.

For each candidate remedial action identified by the action identification module 215, the value computation module 217 computes a value associated with the candidate remedial action. For example, the value computation module 217 may compute an expected value associated with each candidate remedial action identified by the action identification module 215. The value computation module 217 may compute the value associated with a candidate remedial action based on a predicted likelihood that a user who has placed a new order for pickup from a source location during a pickup timeframe will pick up the new order if the candidate remedial action is taken, one or more additional values (e.g., costs) associated with the candidate remedial action, or any other suitable types of information. Examples of such additional values include: a cost of providing an incentive to pick up the new order, a cost of storing one or more items included in the new order until a later timeframe, a cost of delivering the new order to a delivery location associated with the user (less any delivery fee), or a cost of one or more items included in the new order that cannot be restocked or resold. Additional examples of additional values associated with a candidate remedial action include: a cost of restocking one or more items included in the new order (less any restocking fee), a cost of a discount at which the new order is offered to one or more additional users, etc.

To illustrate an example of how the value computation module 217 may compute a value associated with a candidate remedial action, suppose that the pickup prediction module 216 predicts a 60% likelihood that a user who has placed a new order for pickup from a source location during a pickup timeframe will pick up the new order if a candidate remedial action is taken. In this example, suppose also that the candidate remedial action corresponds to offering the user a coupon for $5.00 off a subsequent order if they pick up the new order, that a total value of the items included in the new order is $100.00, and that a $10.00 item included in the new order cannot be restocked or resold. In this example, the value computation module 217 may compute an expected value associated with the candidate remedial action by subtracting the product of the probability of a negative outcome (40%) and a cost of the potential loss of the item that cannot be restocked or resold ($10.00) from the product of the probability of a positive outcome (60%) and the potential return (total value of $100.00—incentive of $5.00). Continuing with this example, the expected value may be computed as: [0.6×($100.00−$5.00)]−[0.4×$10.00]=$53.00.

In embodiments in which a value computed by the value computation module 217 is associated with a candidate remedial action corresponding to offering a new order to one or more additional users of the online system 140 (e.g., at a discount), the value also may be computed based on a predicted likelihood that each additional user will accept the new order (e.g., for pickup or delivery). In such embodiments, the value computation module 217 may retrieve user data for additional users of the online system 140 (e.g., from the data store 240), identify the additional user(s), and predict the likelihood for each additional user. The value computation module 217 may predict the likelihood for each additional user based on a set of user data for the additional user, a set of order data for the new order, the discount (if any), or any other suitable types of information. For example, suppose that a user has placed a new order for pickup from a source location and that the action identification module 215 has identified a candidate remedial action associated with the new order corresponding to offering the new order to another user of the online system 140 at a discount. In this example, the value computation module 217 may retrieve user data for additional users of the online system 140 from the data store 240 and identify one or more of the additional users within a threshold distance of the source location based on a current location associated with the additional users (e.g., a location of a user client device 100 associated with each additional user). Continuing with this example, based on historical conversion information describing items previously ordered or purchased by each additional user, order data for the new order, and the discount, the value computation module 217 may predict a likelihood that each additional user will accept the new order at the discount. In this example, the value computation module 217 may compute an expected value associated with the candidate remedial action based on a cost of the discount and an average of the predicted likelihood(s).

In embodiments in which the value computation module 217 predicts a likelihood that a user will accept a new order (e.g., for pickup or delivery, at a discount, etc.), the value computation module 217 may make the prediction using an acceptance prediction model. An acceptance prediction model is a machine-learning model trained to predict a likelihood that a user who is offered a new order that is placed by a different user for pickup from a source location will accept the new order (e.g., for pickup from the source location or for delivery, at a discount, etc.). To use the acceptance prediction model, the value computation module 217 may access the model (e.g., from the data store 240) and apply the model to a set of inputs. The set of inputs may include data (e.g., user data, order data, etc.) retrieved by the value computation module 217 described above, a discount on the new order (if any), information describing whether the new order is being offered for pickup or delivery, or any other suitable types of information. For example, the value computation module 217 may access and apply the acceptance prediction model to a set of order data describing a new order placed for pickup from a source location, a set of inputs including a set of user data for a user to whom the new order may be offered, and a discount at which the new order may be offered to the user. Once the value computation module 217 applies the acceptance prediction model to the set of inputs, the value computation module 217 may receive an output from the model, which may include a value corresponding to the likelihood that the user will accept the new order (e.g., for pickup or delivery, at a discount, etc.). In some embodiments, the acceptance prediction model is trained by the machine-learning training module 230, as described below.

In some embodiments, rather than using the acceptance prediction model, the value computation module 217 predicts a likelihood that a user will accept a new order using a different machine-learning model. The value computation module 217 may do so while the data collection module 200 collects a set of training examples used to train the acceptance prediction model. For example, the value computation module 217 may predict a likelihood that a user will accept a new order using the item selection model described above for each of multiple items included in the new order and predict a likelihood that the user will accept the new order based on scores for the items (e.g., such that the predicted likelihood is proportional to an average of the scores and any discount associated with the new order). Alternatively, in the above example, the value computation module 217 may predict the likelihood that the user will accept the new order using an order selection model that uses an order embedding describing the new order (e.g., items included in the new order, any discount associated with the new order, etc.) and a user embedding describing the user to score the new order. In this example, the value computation module 217 may then predict the likelihood based on the score (e.g., such that the predicted likelihood is proportional to the score). In this example, the order embedding and user embedding may be generated by separate machine-learning models and may be stored in the data store 240.

The order management module 220 manages orders for items from users. The order management module 220 receives orders from user client devices 100 and offers the orders to pickers for service based on picker data. For example, the order management module 220 offers an order to a picker based on the picker's location and the source location from which the ordered items are to be collected. The order management module 220 may also offer an order to a picker based on how many items are in the order, a vehicle operated by the picker, the delivery location, the picker's preferences for how far to travel to deliver an order, the picker's ratings by users, or how often the picker agrees to service an order.

In some embodiments, the order management module 220 determines when to offer an order to a picker based on a delivery timeframe requested by the user who placed the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions indicating how the picker may travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model is used by the machine-learning model to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

In embodiments in which the pickup prediction module 216 accesses and applies the pickup prediction model to predict a likelihood that a user who has placed a new order for pickup from a source location during a pickup timeframe will pick up the order if a candidate remedial action is taken, the machine-learning training module 230 may train the pickup prediction model. The machine-learning training module 230 may train the pickup prediction model via supervised learning or using any other suitable technique or combination of techniques based on data stored in the data store 240 or any other suitable types of data. For example, the machine-learning training module 230 may train the pickup prediction model based on user data, item data, order data, or any other types of data stored in the data store 240.

To illustrate an example of how the machine-learning training module 230 may train the pickup prediction model, suppose that the machine-learning training module 230 receives a set of training examples. In this example, the set of training examples may include order data describing various attributes of orders previously placed for pickup from one or more source locations, in which the order data includes a set of messages sent to user client devices 100 associated with users of the online system 140 who placed the orders. In the above example, the set of training examples also may include user data describing various attributes of the users who placed the orders, such as historical conversion information associated with each user, each user's preferences, demographic or household information associated with each user, etc. In the above example, the set of training examples also may include labels which represent expected outputs of the pickup prediction model, in which a label describes, for each order, whether a user who placed the order picked up the order. Continuing with this example, the machine-learning training module 230 may then update a set of parameters of the pickup prediction model based on the attributes, as well as the labels by comparing its output from input data of each training example to the label for the training example. In the above example, the machine-learning training module 230 subsequently may retrain the pickup prediction model or improve its predictions via reinforcement learning after receiving sufficient training data indicating how users responded to remedial actions that were taken (if any) (e.g., whether the users subsequently picked up the orders, whether the users subsequently placed additional orders, etc.).

In embodiments in which the value computation module 217 accesses and applies the acceptance prediction model to predict a likelihood that a user will accept a new order (e.g., for pickup or delivery, at a discount, etc.), the machine-learning training module 230 may train the acceptance prediction model. The machine-learning training module 230 may train the acceptance prediction model via supervised learning or using any other suitable technique or combination of techniques based on data stored in the data store 240 or any other suitable types of data. For example, the machine-learning training module 230 may train the acceptance prediction model based on user data, item data, order data, or any other types of data stored in the data store 240.

To illustrate an example of how the machine-learning training module 230 may train the acceptance prediction model, suppose that the machine-learning training module 230 receives a set of training examples. In this example, the set of training examples may include order data describing various attributes of orders previously offered to users of the online system 140, in which the order data includes information describing a set of discounts associated with the orders and an amount of each discount (if any). In the above example, the attributes may describe each item included in each order (e.g., an item identifier, an item category, a size, a brand, a quantity, a price, a perishability, storage requirements, packaging information, etc. associated with each item), a number of each item included in each order, a total value of the items included in each order, a source location from which the items included in each order were collected, etc. In the above example, the set of training examples also may include user data describing various attributes of the users to whom the orders were offered, such as historical conversion information associated with each user, each user's preferences, demographic or household information associated with each user, etc. In the above example, the machine-learning training module 230 also may receive labels which represent expected outputs of the acceptance prediction model, in which a label indicates, for each order, whether a user who was offered the order accepted it. Continuing with this example, the machine-learning training module 230 may then update a set of parameters of the acceptance prediction model based on the attributes, as well as the labels by comparing its output from input data of each training example to the label for the training example. In the above example, the machine-learning training module 230 subsequently may retrain the acceptance prediction model or improve its predictions via reinforcement learning after receiving sufficient additional training data indicating whether users to whom orders were offered subsequently accepted the orders.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases in which the training example includes a label, the loss function is also based on the label for the training example. Some example loss functions include the mean square error function, the mean absolute error, the hinge loss function, and the cross-entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 retrains the machine-learning model using the additional training data, using any of the methods described above. This deployment and retraining process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

### Messaging an Online System User Based on Predicted Likelihoods of Order Pickup in Response to Remedial Actions

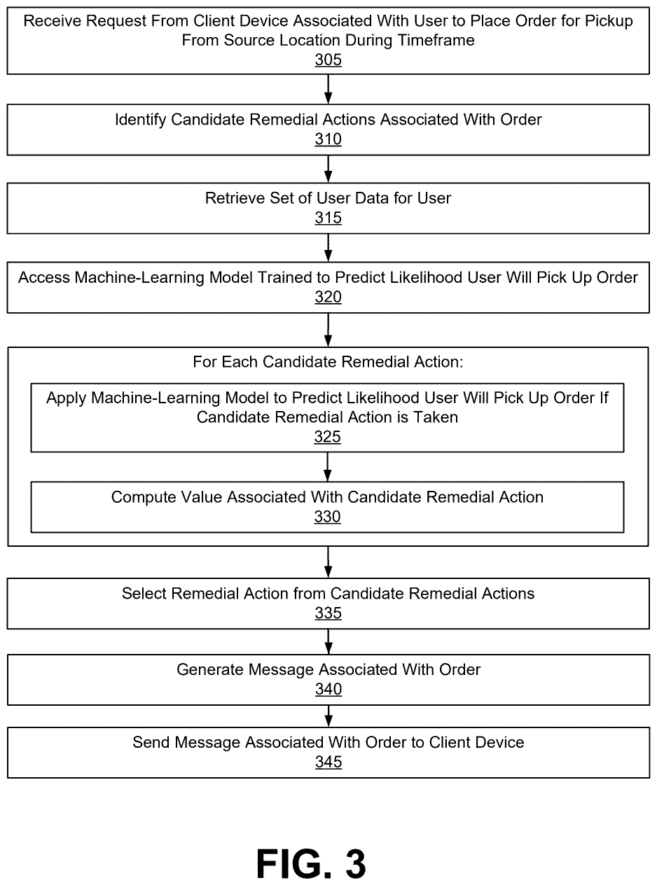

FIG. 3 is a flowchart for a method for messaging an online system user based on predicted likelihoods the user will pick up an order in response to remedial actions, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

The online system 140 receives 305 (e.g., via the interface module 211) a request from a user client device 100 associated with a user of the online system 140 to place a new order for pickup from a source location during a pickup timeframe. The request may include information describing the user, the pickup timeframe, the source location, each item included in the new order (e.g., an item identifier, an item category, a brand, a price, a perishability, storage requirements, packaging information, etc. associated with each item), a number of each item included in the new order, a total value of the items included in the new order, etc. The pickup timeframe during which the new order is to be picked up from the source location may be specified by the user (e.g., a one-hour window the user selected from multiple possible one-hour windows after a time the new order is placed).

The online system 140 then identifies 310 (e.g., using the action identification module 215) candidate remedial actions associated with the new order. The online system 140 may do so based on the pickup timeframe and a current time (e.g., by determining, using the action identification module 215, whether the current time is before, within, or after the pickup timeframe) or based on any other suitable types of information. Examples of candidate remedial actions include: reminding the user to pick up the new order, providing an incentive (e.g., a coupon for a subsequent order, a free item, etc.) for the user to pick up the new order, suggesting a later pickup timeframe for the new order (e.g., with a discount available for earlier timeframes), or suggesting the new order be delivered to a delivery location associated with the user (e.g., with a delivery fee). Additional examples of candidate remedial actions include: cancelling the new order, restocking one or more items included in the new order (e.g., with a restocking fee), offering the new order to another user of the online system 140 (e.g., for pickup or delivery, at a discount, etc.), or any other suitable types of candidate remedial actions. In embodiments in which a candidate remedial action identified 310 by the online system 140 is associated with an incentive, a discount, or a fee, additional candidate remedial actions identified 310 by the online system 140 may be of the same type, but associated with different incentives, discounts, or fees. Furthermore, in such embodiments, the incentive, discount, or fee may be determined by the online system 140 (e.g., using the action identification module 215). The online system 140 may make the determination based on order data for the new order (e.g., a total value of the items included in the new order, an amount of a restocking fee associated with the new order, etc.), user data for the user (e.g., a net present value (NPV) associated with the user, a newness of the user to the online system 140), or any other suitable types of information.

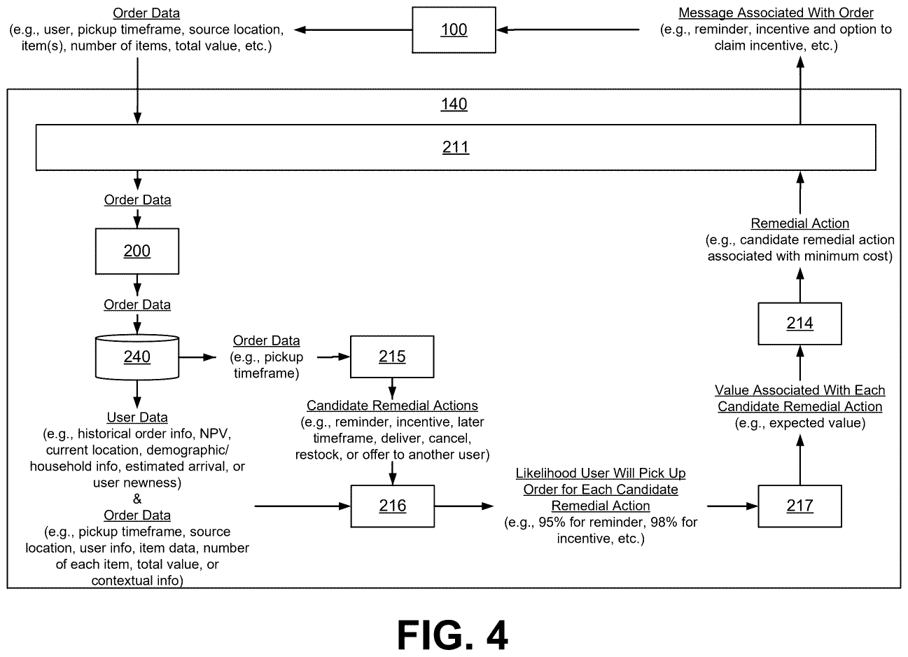

FIG. 4 is a process flow diagram for messaging an online system user based on predicted likelihoods the user will pick up an order in response to remedial actions, in accordance with one or more embodiments. As shown in FIG. 4, suppose that the online system 140 determines that a current time or an estimated arrival time for the user at the source location derived by the online system 140 (e.g., using the data collection module 200) is before or within the pickup timeframe. In this example, the online system 140 may identify (step 310) candidate remedial actions associated with the new order including reminding the user to pick up the new order, providing an incentive (e.g., a coupon for a subsequent order, a free item, etc.) for the user to pick up the new order, suggesting a later pickup timeframe for the new order (e.g., with a discount available for earlier timeframes), or suggesting the new order be delivered to a delivery location associated with the user. Alternatively, in the above example, suppose that the online system 140 determines that the current time or the estimated arrival time for the user at the source location is after the pickup timeframe. In this example, the online system 140 also or alternatively may identify (step 310) additional candidate remedial actions associated with the new order including cancelling the new order, restocking one or more items included in the new order, or offering the new order to another user of the online system 140 at a discount.

Referring back to FIG. 3, the online system 140 then retrieves 315 (e.g., using the pickup prediction module 216) a set of user data for the user (e.g., from the data store 240). For example, as shown in FIG. 4, the online system 140 may retrieve 315 the set of user data including historical order information describing previous orders the user placed with one or more sources. In this example, the historical order information may include item data describing items included in each previous order, a number of each item included in each previous order, a total value of the items included in each previous order, a time each previous order was placed, a source location from which the items included in each previous order were collected, and a pickup timeframe for each previous order. Continuing with this example, the historical order information also may describe a time at which the user picked up each previous order (if any) or any incentives (e.g., coupons for subsequent orders, free items, etc.), discounts, or fees (e.g., delivery or restocking fees) associated with each previous order (e.g., a type or an amount of each incentive, an amount of each discount or fee, etc.). In this example, the historical order information further may include a historical rate at which the user picked up their previous pickup orders or a percentage of the previous pickup orders that the user picked up (e.g., before, within, or after pickup timeframes for the orders). In the above example, the historical order information also may include contextual information associated with each previous order, such as a set of weather conditions (e.g., rain, hail, snow, etc.), a set of traffic conditions (e.g., an amount of traffic, a number of detours, etc.), a day of the week, a time of the day, etc. associated with picking up each previous order. Continuing with this example, the set of user data also may include a net present value (NPV), a current location, or demographic or household information associated with the user, an estimated arrival time for the user at the source location from which the new order is to be picked up, or information indicating whether the user is new to the online system 140.

In some embodiments, the online system 140 also retrieves (step 315) additional types of data (e.g., from the data store 240), such as a set of order data for the new order, or any other suitable types of data. As shown in FIG. 4, the set of order data for the new order retrieved 315 by the online system 140 also may describe the pickup timeframe for the new order, the source location from which the new order is to be picked up, and information describing the user. In this example, the set of order data also may include the item data for items included in the new order, such as an item identifier, an item category, a size, a brand, a quantity, a price, a perishability, storage requirements, packaging information, restocking or reselling procedures, any costs (e.g., restocking or storage), etc. associated with each item. Continuing with this example, the set of order data also may describe a number of each item included in the new order and a total value of the items included in the new order. In the above example, the set of order information also may include contextual information associated with the new order, such as a set of weather conditions (e.g., rain, hail, snow, etc.), a set of traffic conditions (e.g., an amount of traffic, a number of detours, etc.), a day of the week, a time of the day, etc. associated with picking up the new order.

For each candidate remedial action identified 310 by the online system 140, the online system 140 predicts (e.g., using the pickup prediction module 216) a likelihood that the user will pick up the new order if the candidate remedial action is taken. The online system 140 may do so based on the set of user data for the user, the set of order data for the new order, or any other suitable types of information. For example, suppose that historical order information indicates that the user has always picked up orders they placed for pickup during pickup timeframes for the orders, that the user has never had orders delivered to them, and that the user often orders items that are on sale. In the above example, suppose also that the new order is very similar to the user's previous orders (e.g., based on items included in the orders, contextual information associated with picking up the orders, etc.). Continuing with this example, the online system 140 may predict a likelihood that the user will pick up the new order if each of the remedial actions identified 310 by the online system 140 is taken (e.g., 95% if the user is reminded to pick up the new order, 98% if the user is provided with an incentive to pick up the new order, etc., as shown in FIG. 4). In various embodiments, the online system 140 predicts multiple likelihoods that the user will pick up the new order for each candidate remedial action (e.g., as the pickup timeframe approaches, when the current time is within the pickup timeframe, or when the pickup timeframe has passed). In some embodiments, the online system 140 also predicts a likelihood that the user will pick up the new order if no remedial action is taken. In such embodiments, the online system 140 may determine (e.g., using the pickup prediction module 216) whether the predicted likelihood is at least a threshold likelihood and may only predict the likelihood for each candidate remedial action if the predicted likelihood is less than the threshold likelihood.

Referring back to FIG. 3, in some embodiments, the online system 140 predicts the likelihood that the user will pick up the new order if a candidate remedial action is taken using a pickup prediction model. A pickup prediction model is a machine-learning model trained to predict a likelihood that a user who has placed an order for pickup from a source location during a pickup timeframe will pick up the order if a set of candidate remedial actions is taken. To use the pickup prediction model, the online system 140 may access 320 (e.g., using the pickup prediction module 216) the model (e.g., from the data store 240) and apply 325 (e.g., using the pickup prediction module 216) the model to a set of inputs. The set of inputs may include data retrieved 315 by the online system 140 described above, information describing a set of candidate remedial actions, or any other suitable types of information. Once the online system 140 applies 325 the pickup prediction model to the set of inputs, the online system 140 may receive (e.g., via the pickup prediction module 216) an output from the model, which may include a value corresponding to the likelihood that the user will pick up the new order if the set of candidate remedial actions is taken. In some embodiments, the pickup prediction model is trained by the online system 140 (e.g., using the machine-learning training module 230).

For each candidate remedial action identified 310 by the online system 140, the online system 140 also computes 330 (e.g., using the value computation module 217) a value associated with the candidate remedial action. For example, as shown in FIG. 4, the online system 140 may compute 330 an expected value associated with each candidate remedial action. The online system 140 may compute 330 the value associated with a candidate remedial action based on a predicted likelihood that the user will pick up the new order if the candidate remedial action is taken, one or more additional values (e.g., costs) associated with the candidate remedial action, or any other suitable types of information. Examples of such additional values include: a cost of providing an incentive to pick up the new order, a cost of storing one or more items included in the new order until a later timeframe, a cost of delivering the new order to a delivery location associated with the user (less any delivery fee), or a cost of one or more items included in the new order that cannot be restocked or resold. Additional examples of additional values associated with a candidate remedial action include: a cost of restocking one or more items included in the new order (less any restocking fee), a cost of a discount at which the new order is offered to one or more additional users, etc.

In embodiments in which the value computed 330 by the online system 140 is associated with a candidate remedial action corresponding to offering the new order to one or more additional users of the online system 140 (e.g., at a discount), the value also may be computed 330 based on a predicted likelihood that each additional user will accept the new order (e.g., for pickup or delivery). In such embodiments, the online system 140 may retrieve (e.g., using the value computation module 217) user data for additional users of the online system 140 (e.g., from the data store 240), identify (e.g., using the value computation module 217) the additional user(s), and predict (e.g., using the value computation module 217) the likelihood for each additional user. The online system 140 may predict the likelihood for each additional user based on a set of user data for the additional user (e.g., a current location, historical conversion information, etc. associated with the additional user), the set of order data for the new order, the discount (if any), or any other suitable types of information.

In embodiments in which the online system 140 predicts a likelihood that an additional user will accept the new order, the online system 140 may do so using an acceptance prediction model. An acceptance prediction model is a machine-learning model trained to predict a likelihood that a user who is offered a new order that is placed by a different user for pickup from a source location will accept the new order (e.g., for pickup from the source location or for delivery, at a discount, etc.). To use the acceptance prediction model, the online system 140 may access (e.g., using the value computation module 217) the model (e.g., from the data store 240) and apply (e.g., using the value computation module 217) the model to a set of inputs. The set of inputs may include a set of user data for the additional user, the set of order data for the new order, a discount on the new order (if any), information describing whether the new order is being offered for pickup or delivery, or any other suitable types of information. Once the online system 140 applies the acceptance prediction model to the set of inputs, the online system 140 may receive (e.g., via the value computation module 217) an output from the model, which may include a value corresponding to the likelihood that the additional user will accept the new order (e.g., for pickup or delivery, at a discount, etc.). In some embodiments, the acceptance prediction model is trained by the online system 140 (e.g., using the machine-learning training module 230). In some embodiments, rather than using the acceptance prediction model, the online system 140 predicts the likelihood that the additional user will accept the new order using a different machine-learning model (e.g., the item selection model, an order selection model, etc.). The online system 140 may do so while it collects (e.g., using the data collection module 200) a set of training examples used to train the acceptance prediction model.

Referring again to FIG. 3, once the online system 140 computes 330 the value associated with each candidate remedial action, the online system 140 may select 335 (e.g., using the selection module 214) a remedial action from the candidate remedial actions. The online system 140 may do so based on the value associated with each candidate remedial action. For example, as shown in FIG. 4, the remedial action selected 335 by the online system 140 may correspond to a candidate remedial action associated with a minimum cost (e.g., a highest expected value). In some embodiments, the online system 140 ranks (e.g., using the ranking module 213) the candidate remedial actions based on the value associated with each candidate remedial action or based on any other suitable types of information and selects 335 the remedial action based on the ranking.

Referring once more to FIG. 3, the online system 140 then generates 340 (e.g., using the interface module 211) a message associated with the new order and sends 345 (e.g., using the interface module 211) the message to the user client device 100 associated with the user, causing the user client device 100 to display the message. The message generated 340 by the online system 140 may include a set of selectable options. Examples of selectable options that may be included in the message include: an option to claim an incentive (e.g., a coupon for a subsequent order, a free item, etc.) for picking up the new order, an option to accept a later pickup timeframe for the new order (e.g., with a discount available for earlier timeframes), an option to change the new order from a pickup order to a delivery order, an option to cancel the new order, etc. The online system 140 may generate 340 the message based on the remedial action selected 335 by the online system 140 or based on any other suitable types of information. For example, as shown in FIG. 4, if the remedial action selected 335 by the online system 140 corresponds to reminding the user to pick up the new order, the message may include a reminder to pick up the new order from the source location within the pickup timeframe. Alternatively, in the above example, if the remedial action corresponds to providing an incentive for the user to pick up the new order, in which the incentive corresponds to a free item, the message may instead describe the incentive and include an option to claim the free item once the user arrives at the source location. In some embodiments, the online system 140 sends 345 the message to the user client device 100 once it generates 340 the message, while in other embodiments, it sends 345 the message at a later time (e.g., after the pickup timeframe for the new order has passed).

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, at an online system, a request from a client device associated with a user of the online system to place an order for pickup from a source location during a timeframe;
identifying a plurality of candidate remedial actions associated with the order based at least in part on the timeframe and a current time;
retrieving a set of user data for the user, wherein the set of user data comprises historical order information associated with the user;
accessing a machine-learning model trained to predict a likelihood that the user will pick up the order, wherein the machine-learning model is trained by:
receiving order data for a plurality of orders placed for pickup from one or more source locations, wherein the order data comprises a set of messages sent to a plurality of client devices associated with a plurality of users of the online system who placed the plurality of orders,
receiving user data for the plurality of users,
receiving, for each order of the plurality of orders, a label indicating whether a corresponding user picked up a corresponding order, and
updating a set of parameters of the machine-learning model based at least in part on the order data, the user data, and the label for each order of the plurality of orders;
for each candidate remedial action of the plurality of candidate remedial actions:
applying the machine-learning model to predict the likelihood that the user will pick up the order if the candidate remedial action is taken based at least in part on the set of user data for the user and a set of order data for the order; and
generating a value associated with the candidate remedial action based at least in part on the likelihood that the user will pick up the order if the candidate remedial action is taken;
selecting a remedial action from the plurality of candidate remedial actions based at least in part on the value associated with each candidate remedial action of the plurality of candidate remedial actions;
generating a message associated with the order based at least in part on the selected remedial action, wherein the message comprises a set of selectable options; and
sending the message to the client device associated with the user, wherein the sending causes the client device to display the message.

2. The method of claim 1, wherein identifying the plurality of candidate remedial actions associated with the order based at least in part on the timeframe and the current time comprises:
detecting that one or more of the current time is before the timeframe or the current time is within the timeframe; and
responsive to detecting that one or more of: the current time is before the timeframe or the current time is within the timeframe, identifying the plurality of candidate remedial actions associated with the order, wherein the plurality of candidate remedial actions comprises one or more of: reminding the user to pick up the order, providing an incentive for the user to pick up the order, suggesting a later timeframe for picking up the order from the source location, or suggesting the order be delivered to a delivery location associated with the user.

3. The method of claim 2, wherein generating the value associated with the candidate remedial action based at least in part on the likelihood that the user will pick up the order if the candidate remedial action is taken comprises:
generating the value associated with the candidate remedial action based on one or more of: a value associated with the incentive, a value associated with storing one or more items included in the order until the later timeframe, or a value associated with delivering the order to the delivery location associated with the user.

4. The method of claim 1, wherein identifying the plurality of candidate remedial actions associated with the order based at least in part on the timeframe and the current time comprises:
detecting that the current time is after the timeframe; and
responsive to detecting that the current time is after the timeframe, identifying the plurality of candidate remedial actions associated with the order, wherein the plurality of candidate remedial actions comprises one or more of: reminding the user to pick up the order, providing an incentive for the user to pick up the order, suggesting a later timeframe for picking up the order from the source location, suggesting the order be delivered to a delivery location associated with the user, cancelling the order, restocking one or more items included in the order, or offering the order to an additional user of the online system at a discount.

5. The method of claim 4, wherein generating the value associated with the candidate remedial action based at least in part on the likelihood that the user will pick up the order if the candidate remedial action is taken comprises:
generating the value associated with the candidate remedial action based on one or more of: a value associated with the incentive, a value associated with storing one or more items included in the order until the later timeframe, a value associated with delivering the order to the delivery location associated with the user, a value associated with restocking one or more items included in the order, a value associated with the discount, a value associated with one or more items included in the order that cannot be restocked, or a value associated with one or more items included in the order that cannot be resold.

6. The method of claim 4, wherein generating the value associated with the candidate remedial action based at least in part on the likelihood that the user will pick up the order if the candidate remedial action is taken comprises:
accessing an additional machine-learning model trained to predict an additional likelihood that the additional user will accept the order at the discount, wherein the additional machine-learning model is trained by:
receiving additional order data for an additional plurality of orders offered to an additional plurality of users of the online system, wherein the additional order data comprises information describing a set of discounts associated with the additional plurality of orders,
receiving additional user data for the additional plurality of users,
receiving, for each order of the additional plurality of orders, an additional label indicating whether a user who was offered an additional corresponding order accepted the additional corresponding order, and
updating a set of parameters of the additional machine-learning model based at least in part on the additional order data, the additional user data, and the additional label for each order of the additional plurality of orders;
retrieving an additional set of user data for each user of a plurality of users;
identifying one or more users of the online system associated with a location within a threshold distance of the source location based at least in part on the additional set of user data for each user of the one or more users;
for each user of the one or more users, applying the additional machine-learning model to predict the additional likelihood that a corresponding user will accept the order at the discount based at least in part on the additional set of user data for the corresponding user and the set of order data for the order; and
generating the value associated with the candidate remedial action based on the additional likelihood that each user of the one or more users will accept the order at the discount.

7. The method of claim 1, wherein selecting the remedial action from the plurality of candidate remedial actions based at least in part on the value associated with each candidate remedial action of the plurality of candidate remedial actions comprises:
ranking the plurality of candidate remedial actions based at least in part on the value associated with each candidate remedial action of the plurality of candidate remedial actions; and
selecting the remedial action from the plurality of candidate remedial actions based at least in part on the ranking.

8. The method of claim 1, wherein applying the machine-learning model to predict the likelihood that the user will pick up the order if the candidate remedial action is taken based at least in part on the set of user data for the user and the set of order data for the order comprises:
applying the machine-learning model to predict the likelihood that the user will pick up the order if the candidate remedial action is taken based on a set of contextual information associated with the order, wherein the set of contextual information comprises one or more of: a set of weather conditions associated with picking up the order or a set of traffic conditions associated with picking up the order.

9. The method of claim 1, further comprising:
retrieving the set of order data for the order, wherein the set of order data comprises one or more of: an item category associated with an item included in the order, a perishability of an item included in the order, a number of an item included in the order, a restocking procedure for an item included in the order, or a set of storage requirements associated with an item included in the order.

10. The method of claim 1, wherein retrieving the set of user data for the user comprises:
retrieving one or more of: information describing a historical rate at which the user picked up previous orders, an estimated arrival time for the user at the source location, or a net present value associated with the user.

11. A computer program product comprising a non-transitory computer-readable storage medium having instructions encoded thereon that, when executed by a processor, cause the processor to perform steps comprising:
receiving, at an online system, a request from a client device associated with a user of the online system to place an order for pickup from a source location during a timeframe;
identifying a plurality of candidate remedial actions associated with the order based at least in part on the timeframe and a current time;
retrieving a set of user data for the user, wherein the set of user data comprises historical order information associated with the user;
accessing a machine-learning model trained to predict a likelihood that the user will pick up the order, wherein the machine-learning model is trained by:
receiving order data for a plurality of orders placed for pickup from one or more source locations, wherein the order data comprises a set of messages sent to a plurality of client devices associated with a plurality of users of the online system who placed the plurality of orders,
receiving user data for the plurality of users,
receiving, for each order of the plurality of orders, a label indicating whether a corresponding user picked up a corresponding order, and
updating a set of parameters of the machine-learning model based at least in part on the order data, the user data, and the label for each order of the plurality of orders;
for each candidate remedial action of the plurality of candidate remedial actions:
applying the machine-learning model to predict the likelihood that the user will pick up the order if the candidate remedial action is taken based at least in part on the set of user data for the user and a set of order data for the order; and
generating a value associated with the candidate remedial action based at least in part on the likelihood that the user will pick up the order if the candidate remedial action is taken;
selecting a remedial action from the plurality of candidate remedial actions based at least in part on the value associated with each candidate remedial action of the plurality of candidate remedial actions;
generating a message associated with the order based at least in part on the selected remedial action, wherein the message comprises a set of selectable options; and
sending the message to the client device associated with the user, wherein the sending causes the client device to display the message.

12. The computer program product of claim 11, wherein identifying the plurality of candidate remedial actions associated with the order based at least in part on the timeframe and the current time comprises:
detecting that one or more of the current time is before the timeframe or the current time is within the timeframe; and
responsive to detecting that one or more of: the current time is before the timeframe or the current time is within the timeframe, identifying the plurality of candidate remedial actions associated with the order, wherein the plurality of candidate remedial actions comprises one or more of: reminding the user to pick up the order, providing an incentive for the user to pick up the order, suggesting a later timeframe for picking up the order from the source location, or suggesting the order be delivered to a delivery location associated with the user.

13. The computer program product of claim 12, wherein generating the value associated with the candidate remedial action based at least in part on the likelihood that the user will pick up the order if the candidate remedial action is taken comprises:
generating the value associated with the candidate remedial action based on one or more of: a value associated with the incentive, a value associated with storing one or more items included in the order until the later timeframe, or a value associated with delivering the order to the delivery location associated with the user.

14. The computer program product of claim 11, wherein identifying the plurality of candidate remedial actions associated with the order based at least in part on the timeframe and the current time comprises:
detecting that the current time is after the timeframe; and
responsive to detecting that the current time is after the timeframe, identifying the plurality of candidate remedial actions associated with the order, wherein the plurality of candidate remedial actions comprises one or more of: reminding the user to pick up the order, providing an incentive for the user to pick up the order, suggesting a later timeframe for picking up the order from the source location, suggesting the order be delivered to a delivery location associated with the user, cancelling the order, restocking one or more items included in the order, or offering the order to an additional user of the online system at a discount.

15. The computer program product of claim 14, wherein generating the value associated with the candidate remedial action based at least in part on the likelihood that the user will pick up the order if the candidate remedial action is taken comprises:
generating the value associated with the candidate remedial action based on one or more of: a value associated with the incentive, a value associated with storing one or more items included in the order until the later timeframe, a value associated with delivering the order to the delivery location associated with the user, a value associated with restocking one or more items included in the order, a value associated with the discount, a value associated with one or more items included in the order that cannot be restocked, or a value associated with one or more items included in the order that cannot be resold.

16. The computer program product of claim 14, wherein generating the value associated with the candidate remedial action based at least in part on the likelihood that the user will pick up the order if the candidate remedial action is taken comprises:
accessing an additional machine-learning model trained to predict an additional likelihood that the additional user will accept the order at the discount, wherein the additional machine-learning model is trained by:
receiving additional order data for an additional plurality of orders offered to an additional plurality of users of the online system, wherein the additional order data comprises information describing a set of discounts associated with the additional plurality of orders,
receiving additional user data for the additional plurality of users,
receiving, for each order of the additional plurality of orders, an additional label indicating whether a user who was offered an additional corresponding order accepted the additional corresponding order, and updating a set of parameters of the additional machine-learning model based at least in part on the additional order data, the additional user data, and the additional label for each order of the additional plurality of orders;
retrieving an additional set of user data for each user of a plurality of users;
identifying one or more users of the online system associated with a location within a threshold distance of the source location based at least in part on the additional set of user data for each user of the one or more users;
for each user of the one or more users, applying the additional machine-learning model to predict the additional likelihood that a corresponding user will accept the order at the discount based at least in part on the additional set of user data for the corresponding user and the set of order data for the order; and
generating the value associated with the candidate remedial action based on the additional likelihood that each user of the one or more users will accept the order at the discount.

17. The computer program product of claim 11, wherein selecting the remedial action from the plurality of candidate remedial actions based at least in part on the value associated with each candidate remedial action of the plurality of candidate remedial actions comprises:
ranking the plurality of candidate remedial actions based at least in part on the value associated with each candidate remedial action of the plurality of candidate remedial actions; and
selecting the remedial action from the plurality of candidate remedial actions based at least in part on the ranking.

18. The computer program product of claim 11, wherein applying the machine-learning model to predict the likelihood that the user will pick up the order if the candidate remedial action is taken based at least in part on the set of user data for the user and the set of order data for the order comprises:
applying the machine-learning model to predict the likelihood that the user will pick up the order if the candidate remedial action is taken based on a set of contextual information associated with the order, wherein the set of contextual information comprises one or more of: a set of weather conditions associated with picking up the order or a set of traffic conditions associated with picking up the order.

19. The computer program product of claim 11, wherein the computer-readable storage medium further has instructions encoded thereon that, when executed by the processor, cause the processor to perform steps comprising:
retrieving the set of order data for the order, wherein the set of order data comprises one or more of: an item category associated with an item included in the order, a perishability of an item included in the order, a number of an item included in the order, a restocking procedure for an item included in the order, or a set of storage requirements associated with an item included in the order.

20. A computer system comprising:
a processor; and
a non-transitory computer-readable storage medium storing instructions that, when executed by the processor, perform actions comprising:
receiving, at an online system, a request from a client device associated with a user of the online system to place an order for pickup from a source location during a timeframe;
identifying a plurality of candidate remedial actions associated with the order based at least in part on the timeframe and a current time;
retrieving a set of user data for the user, wherein the set of user data comprises historical order information associated with the user;
accessing a machine-learning model trained to predict a likelihood that the user will pick up the order, wherein the machine-learning model is trained by:
receiving order data for a plurality of orders placed for pickup from one or more source locations, wherein the order data comprises a set of messages sent to a plurality of client devices associated with a plurality of users of the online system who placed the plurality of orders,
receiving user data for the plurality of users,
receiving, for each order of the plurality of orders, a label indicating whether a corresponding user picked up a corresponding order, and
updating a set of parameters of the machine-learning model based at least in part on the order data, the user data, and the label for each order of the plurality of orders;
for each candidate remedial action of the plurality of candidate remedial actions:
applying the machine-learning model to predict the likelihood that the user will pick up the order if the candidate remedial action is taken based at least in part on the set of user data for the user and a set of order data for the order; and
generating a value associated with the candidate remedial action based at least in part on the likelihood that the user will pick up the order if the candidate remedial action is taken;
selecting a remedial action from the plurality of candidate remedial actions based at least in part on the value associated with each candidate remedial action of the plurality of candidate remedial actions;
generating a message associated with the order based at least in part on the selected remedial action, wherein the message comprises a set of selectable options; and
sending the message to the client device associated with the user, wherein the sending causes the client device to display the message.
